(19) United States
(12) Patent Application Publication
(10) Pub. No.: US 2016/0180278 A1
(43) Pub. Date: Jun. 23, 2016

(54) METHODS AND SYSTEMS FOR ASSIGNING TASKS

(71) Applicant: XEROX CORPORATION, Norwalk, CT (US)

(72) Inventors: Laura Elisa Celis, St Sulpice (CH); Shailesh Vaya, Bangalore (IN)

(21) Appl. No.: 14/572,822

(22) Filed: Dec. 17, 2014

(51) Int. Cl. G06Q 10/06

(52) U.S. Cl. CPC G06Q 10/063114

(57) ABSTRACT

According to embodiments illustrated herein there is provided a method for assigning one or more tasks to one or more workers. The method includes creating a graph representative of an acquaintance between the one or more workers based on at least a previous collaboration among said one or more workers in attempting at least previous tasks. Further, at least one set of workers are identified from the one or more workers based on the graph. The workers in said at least one set of workers are unacquainted with each other. Thereafter, one or more sub-tasks in a task are assigned to the workers in at least one set of workers such that the task assigned to the at least one set of workers is different from tasks assigned to other sets of workers.

### TECHNICAL FIELD

The presently disclosed embodiments are related, in general, to crowdsourcing. More particularly, the presently disclosed embodiments are related to methods and systems for assigning tasks to one or more workers.

### BACKGROUND

Crowdsourcing is a process of obtaining needed services, ideas, or content by soliciting contributions from a large group of people, and especially from an online community, rather than from traditional employees or suppliers. This large group of people is commonly referred to as crowdworkers. Crowdsourcing may enable scaling of business processes by outsourcing to a wide and diverse crowd.

Crowdworkers may be linked to each other through various means such as group/guilds, geographical area or vicinity, and/or social networking sites. Thus, different crowdworkers, who are acquainted with each other, may interact, and such collusion of acquainted crowdworkers may lead to disclosure of privacy information included in the crowdsourced tasks. Such disclosure of the privacy information may be undesirable to the requester of the task.

### SUMMARY

According to embodiments illustrated herein, there is provided a system for assigning one or more tasks to one or more workers. The system includes a transceiver configured to receive a request from a computing device associated with a requester over a network, wherein the request comprises at least the one or more tasks and a privacy level associated with the one or more task. The system further includes a processor configured to create a first data structure to define an acquaintance between the one or more workers, based on at least a previous collaboration among the one or more workers in attempting at least previous tasks. The processor is further configured to create one or more second data structures from the first data structure. Each of the one or more second data structures stores information pertaining to at least one set of workers from the one or more workers and the privacy level, wherein workers in the at least one set of workers are unacquainted with each other. The system further includes a buffer configured to store one or more sub-tasks in a task. The processor pulls the one or more sub-tasks from the buffer to assign the one or more sub-tasks to the workers in the at least one set of workers such that the task assigned to the at least one set of workers is different from tasks assigned to other sets of workers.

According to embodiments illustrated herein, there is provided a method for assigning one or more tasks to one or more workers. The method includes receiving, by a transceiver, a request from a computing device associated with a requester, over a network, wherein the request comprises at least one or more tasks and a privacy level associated with the one or more tasks, wherein the one or more tasks are stored in a buffer. The method further includes storing, by a processor, information pertaining to the one or more workers in a first data structure such that the first data structure defines an acquaintance between the one or more workers based on at least a previous collaboration among the one or more workers in attempting at least previous tasks. The method further includes identifying, by the processor, at least one set of workers from said one or more workers based on said privacy level. The workers in the at least one set of workers are unacquainted with each other. The information pertaining to the at least one set of workers is stored in the one or more second data structures. The method further includes extracting, by the processor, one or more sub-tasks from a task, stored in the buffer to assign the one or more sub-tasks to the workers in the at least one set of workers such that the task assigned to the at least one set of workers is different from tasks assigned to other sets of workers.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating a system for assigning one or more tasks to one or more workers, in accordance with at least one embodiment;

FIG. 3 is a flowchart illustrating a method for assigning one or more tasks to one or more workers, in accordance with at least one embodiment;

FIG. 4 is a flowchart illustrating a method to determine set of independent workers, in accordance with at least one embodiment, in accordance with at least one embodiment;

FIG. 5A is a graph illustrating acquaintances between one or more workers, in accordance with at least one embodiment;

FIG. 5B is a graph illustrating identification of one or more sets of independent workers, in accordance with at least one embodiment;

FIG. 6 is a flowchart illustrating a method to identify one or more sets of independent workers, in accordance with at least one embodiment; and

FIG. 7 is a block diagram illustrating a graphical user interface for transmitting or receiving one or more information pertaining to the one or more tasks, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “computing device” refers to a device that includes one or more processors/microcontrollers and/or any other electronic components, or a device or a system that performs one or more operations according to one or more programming instructions/codes. Examples of the computing device may include, but are not limited to, a desktop computer, a laptop, a personal digital assistant (PDA), a mobile device, a Smartphone, a tablet computer (e.g., iPad®, and Samsung Galaxy Tab®), and the like.

“Crowdsourcing” refers to distribution of tasks and obtaining the needed services by soliciting the participation of defined groups of users. A group of users may include, for example, individuals responding to a solicitation posted on a certain website (e.g., crowdsourcing platform), such as Amazon Mechanical Turk or Crowd Flower.

A “crowdsourcing platform” refers to a business application, wherein a broad, loosely defined external group of workers, community, or organization provides solutions as outputs for any specific business processes received by the application as input. In an embodiment, the business application may be hosted online on a web portal. Various examples of the crowdsourcing platforms include, but are not limited to, Amazon Mechanical Turk or Crowd Flower.

A “crowdworker” refers to a worker or a group of workers that may perform one or more crowdsourcing tasks that generate data that contribute to a defined result, such as proofreading part of a digital version of an ancient text or analyzing a small quantum of a large volume of data. Hereinafter, “worker”, “crowdsourced workforce”, “crowdworker”, “crowd workforce”, and “crowd” may be interchangeably used.

A “task” refers to a project, a service, an activity, or a job that may be performed by a crowdworker. A task may include instructions about how to perform the task. Further, a task may comprise features associated with the tasks. Examples of the task features may include, but are not limited to, a day of submitting the task, a time in the day of submitting the task, a cost of the task, and so forth. Further, a task may comprise data that may be processed by the workers. The data may correspond to an image data or a text data in an analog form and/or a digital form retained in at least one of an electronic form or a printed form. Each of the electronic form or the printed form may include one or more images, symbols, text, line art, blank, or non-printed regions etc. In an embodiment, the electronic data may be obtained by scanning a corresponding printed document containing the electronic data. Further, the electronic data may be stored in various file formats, such as, JPG or JPEG, GIF, TIFF, PNG, BMP, RAW, PSD, PSP, PDF, and the like. In an embodiment, the one or more tasks may comprise one or more of, but not limited to, data translation, data transcription, image tagging, article writing, website testing, data verification, logo design, business card design, ads, video, and website design.

A “requester” refers to a person and/or an organization that requests, using a computing device, a crowdsourcing platform to distribute one or more tasks to one or more workers.

A “micro-task” refers to a sub-task of a task. For example, a task may comprise a digital data, such as a filled form. The filled form may comprise different fields. The filled form may be divided such that one or more fields of the form may constitute a sub-task. Thus, the sub-task may be defined as a set of fields that belong to a single conceptual division of the filled form. In an embodiment, a unique id is assigned to each sub-task (segregated from the task). In an embodiment, one or more fields/portions that form a sub-task are so selected that one cannot gain meaningful privacy revealing information from the one or more fields/portions included in a micro-task. Hereinafter, “sub-task” and “micro-task” has been interchangeably used.

An “acquaintance” of a worker refers to an association of a worker with another worker. The other worker may be associated with the worker through one or more of, but not limited to, own group/guilds (e.g., friendship groups, family groups), same geographical area or vicinity, past working history, and/or through social networking websites. In an embodiment, the workers may be acquainted with each other directly or through other workers (i.e., acquaintance of acquaintance). For example, a worker “A” is acquainted to a worker “B” and the worker “B” is acquainted to a worker “C”. Then, the worker “A” is acquainted to worker “C” indirectly.

A “data structure” refers to collection of data stored in a memory. In an embodiment, various operations may be performed to manipulate the data structures. Some examples of data structures may include, but are not limited to, an array, a record, a hash table, a union, graphs, and linked list.

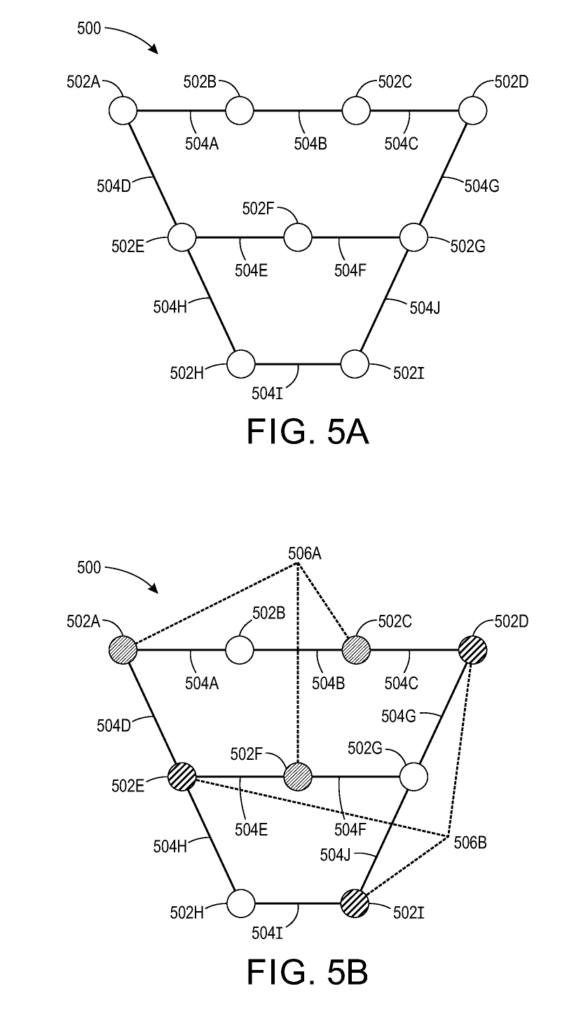

A “graph” refers to a representation of one or more workers. In an embodiment, the graph may include one or more nodes and one or more edges that are utilized to connect the one or more nodes with each other. In a further embodiment, each node is representative of a worker. The edge in the graph corresponds to a relation between the one or more workers. An example graph has been described later in conjunction with FIG. 5A. Hereinafter, the terms “graph” and “social networking graph” are used interchangeably.

A “hop” refers to a number of edges between at least two nodes in a graph. For example, if a worker is one hop away from another worker, it means that there is only one edge between them in the graph. In another example, if a worker is two hops away from another worker, then it means that there are two edges between them in the graph.

A “set of independent workers” refers to a group of workers with no connection/acquaintance between them. For example, three workers, A, B, and C, may not be acquainted with each other in the social graph. In such a case, a set of independent workers may include the workers A, B, and C. Hereinafter, the terms “set of independent workers”, “set of independent workers”, and “independent set” are interchangeably used.

A “degree of a graph” refers to maxima of count of edges originating from a node in the graph. Thus, the node having the greatest number of connections within the graph may determine the degree of the graph. For example, if the degree of a graph is 5, there is at least one node in the graph with 5 edges connected to it.

“Different tasks” refers to non-identical tasks that are not similar in every detail. For example, if there exist two tasks that include handwritten form to be digitized, the two tasks are similar in respect to the template of the forms to be digitized. However, since the two forms may be filled by two different persons, the content in the two forms may be different. Thus, the two tasks so formed for the digitization of the said two forms are non-identical tasks.

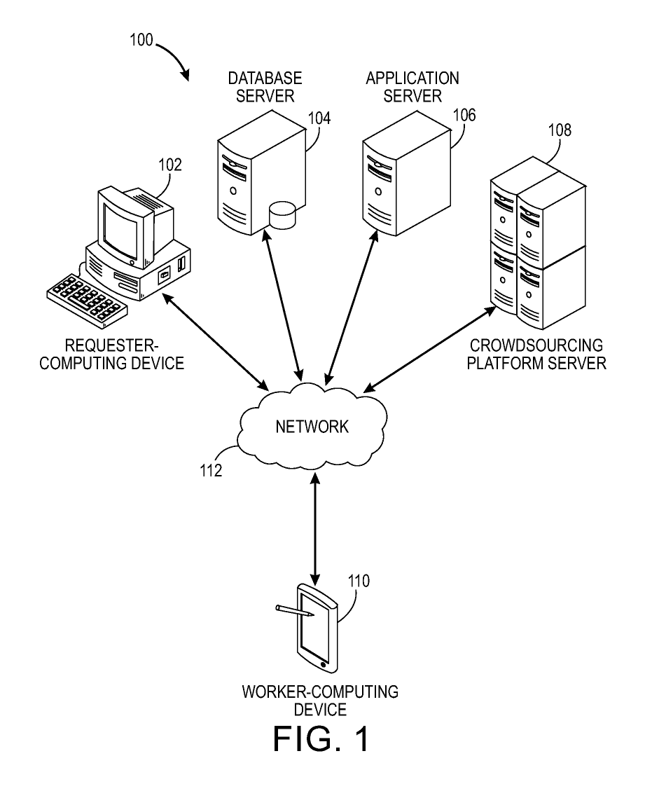

FIG. 1 is a block diagram illustrating a system environment 100 in which various embodiments may be implemented. The system environment 100 includes a requester-computing device 102, a database server 104, an application server 106, a crowdsourcing platform server 108, a worker-computing device 110, and a network 112. Various devices in the system environment 100 may be interconnected over the network 112. FIG. 1 shows, for simplicity, one worker-computing device 110, one requester-computing device 102, one database server 104, one application server 106, and one crowdsourcing platform server 108. However, it will be apparent to a person having ordinary skill in the art that the disclosed embodiments may also be implemented using multiple worker-computing devices 110, multiple requester-computing devices 102, multiple database servers 104, multiple applications servers 106, and multiple crowdsourcing platform servers 108.

The requester-computing device 102 refers to a computing device used by a requester. The requester-computing device 102 may comprise one or more processors in communication with one or more memories. The requester-computing device 102 may be operable to execute one or more sets of instructions stored in the one or more memories. In an embodiment, the requester-computing device 102 may be communicatively coupled with the network 112. In an embodiment, the requester may utilize the requester-computing device 102 to transmit or receive information pertaining to the one or more tasks to/from the crowdsourcing platform server 108 over the network 112. For example, if the crowdsourcing task corresponds to the digitization of the handwritten documents, the requester may transmit, using the requester-computing device 102, the electronic documents that include the handwritten content. The requester-computing device 102 may include various types of computing devices such as, but not limited to, a desktop computer, a laptop, a personal digital assistant (PDA), a mobile device, a Smartphone, a tablet computer (e.g., iPad® and Samsung Galaxy Tab®), and the like.

The database server 104 may refer to a computing device that may store one or more tasks, in accordance with at least one embodiment. In an embodiment, the database server 104 may store one or more instructions/information/features pertaining to one or more tasks. In an embodiment, the database server 104 may store information pertaining to different workers. In an embodiment, the database server 104 may obtain the information pertaining to the one or more workers from various sources such as, but not limited to, social networking websites, databases of various organizations that may provide the rightful authentication to access the information pertaining to the one or more workers. The information pertaining to the one or more workers may comprise, but is not limited to, name, age, qualification, past working history, employment details, and/or information pertaining to acquaintance with other workers. In an embodiment, the database server 104 may be communicatively coupled with the network 112. In an embodiment, the database server 104 may be configured to transmit or receive one or more instructions/tasks/information/features to/from one or more devices, such as the requester-computing device 102, the application server 106, the crowdsourcing platform server 108, etc., over the network 112. In an embodiment, the database server 104 may receive a query from the application server 106 or the crowdsourcing platform server 108 to retrieve the data pertaining to the one or more tasks and/or information pertaining to one or more workers. For querying the database server 104, one or more querying languages may be utilized such as, but are not limited to, SQL, QUEL, DMX, and so forth. Further, the database server 104 may be realized through various technologies such as, but not limited to, Microsoft® SQL server, Oracle, and My SQL.

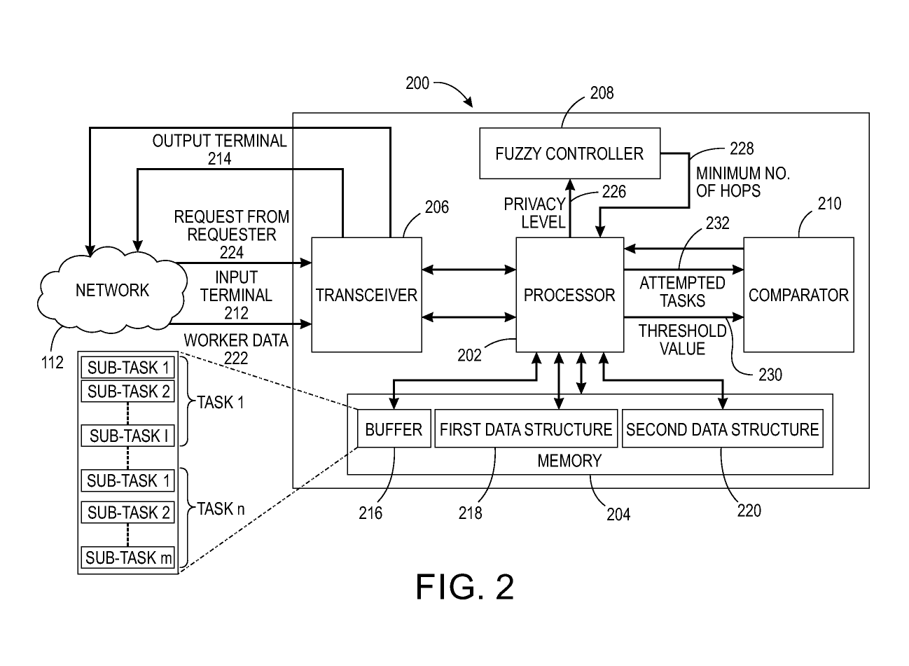

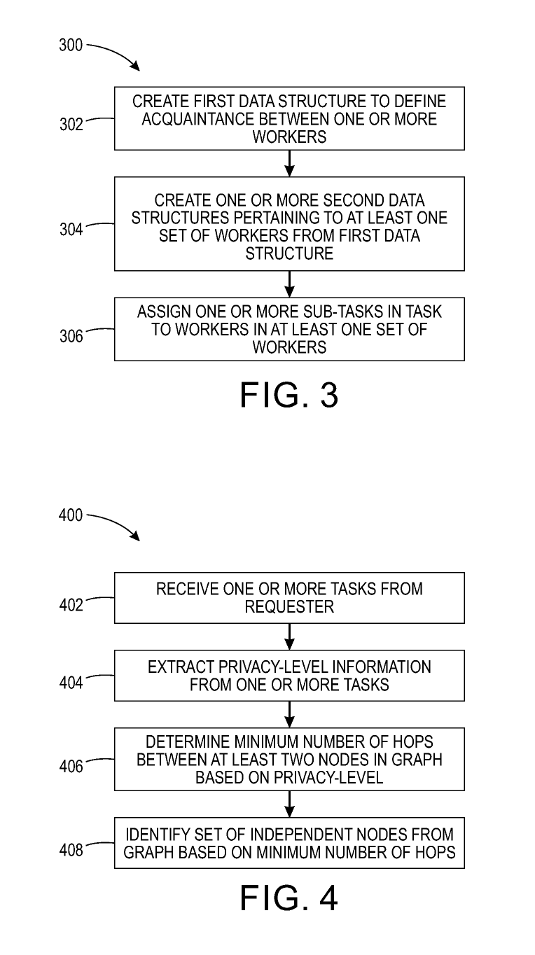

The application server 106 may refer to a computing device or a software framework that may provide a generalized approach to create the application-server implementation. In an embodiment, the function of the application server 106 may be dedicated to the efficient execution of procedures such as, but not limited to, programs, routines, or scripts stored in one or more memories for supporting its applied applications. The application server 106 may be operable to host an application/tool/framework for creating one or more tasks, based on information received from the requester-computing device 102, in accordance with at least one embodiment. In an embodiment, the requester may access the application server 106 over the network 112 to submit the information pertaining to the one or more tasks (e.g., through a web-based interface). In an embodiment, the application server 106 may create a graph that may be representative of the acquaintance between the one or more workers. Prior to creation of the graph, the application server 106 may extract the information pertaining to the one or more workers from the crowdsourcing platform server 108. In an embodiment, the information may correspond to at least acquaintance of a worker with the other one or more workers. The application server 106 may determine a set of workers, from the one or more workers, who are unacquainted with each other. Further, the application server 106 may create one or more sub-tasks from the created tasks such that a single sub-task does not reveal the private information included in the task. Subsequently, the application server 106 may transmit the one or more sub-tasks to the worker-computing device 110 (through the one or more crowdsourcing platforms, such as the crowdsourcing platform server 108). Further details about the determination of the sub-tasks and the distribution of the sub-tasks to the set of workers (that are unacquainted with each other) have been discussed in conjunction with the FIG. 3. The application server 106 may be realized using various technologies such as, but not limited to, Java application server, .NET Framework, PHP, Base4 application server, and Appaserver. The application server 106 has been described later in conjunction with FIG. 2.

A person skilled in the art would understand that the scope of the disclosed invention should not be limited to the database server 104 or the application server 106 as a separate entity. In an embodiment, the functionalities of the database server 104 and the application server 106 may be combined into a single server, without limiting the scope of the inventions.

The crowdsourcing platform server 108 may refer to a computing device that may host one or more crowdsourcing platforms. In an embodiment, one or more workers may be associated with the crowdsourcing platform server 108. In an embodiment, the crowdsourcing platform server 108 may assign/distribute one or more tasks to one or more workers over the network 112. In an embodiment, the crowdsourcing platform server 108 may present user interface (UI) to the one or more workers through a web based interface or a client application installed on the worker-computing device 110. In an embodiment, the one or more workers may access the one or more tasks through the web based interface or the client application. In an embodiment, the one or more workers may submit a final task/product/response to the crowdsourcing platform server 108. In an embodiment, the crowdsourcing platform servers 108 may receive the one or more tasks from the application server 106 and transmit the one or more tasks to the one or more workers. In an embodiment, the crowdsourcing platform servers 108 may itself host the application to create the one or more tasks and sub-tasks. The crowdsourcing platform servers 108 may be realized through an application server such as, but not limited to, Java application server, .NET framework, Base4 application server, and Appaserver.

A person skilled in the art would understand that the scope of the disclosure should not be limited to the database server 104, the application server 106, or the crowdsourcing platform server 108 as a separate entity. In an embodiment, the functionalities of the database server 104, the application server 106, and/or the crowdsourcing platform server 108 may be combined into a single server, without limiting the scope of the invention. In an alternate embodiment, the functionalities of the database server 104 and the application server 106 may be integrated into the crowdsourcing platform server 108.

The worker-computing device 110 may refer to a computing device used by a worker. The worker-computing device 110 may enable the worker to perform/work upon the one or more tasks. In an embodiment, the worker-computing device 110 may be communicatively coupled to the network 112. In an embodiment, a worker may utilize the worker-computing device 110 to submit the responses for the one or more tasks to the crowdsourcing platform over the network 112. The worker-computing device 110 may submit the response using the web interface (provided by the crowdsourcing platform server 108) or using the client application, as discussed above. The worker-computing device 110 may include various types of computing devices such as, but not limited to, a desktop computer, a laptop, a personal digital assistant (PDA), a mobile device, a Smartphone, a tablet computer (e.g., iPad® and Samsung Galaxy Tab®), and the like.

The network 112 corresponds to a medium through which content and messages may flow between one or more of, but not limited to, the requester-computing device 102, the database server 104, the application server 106, the crowdsourcing platform server 108, and/or the worker-computing device 110. Examples of the network 112 may include, but are not limited to, a Wireless Fidelity (Wi-Fi) network, a Wide Area Network (WAN), a Local Area Network (LAN), or a Metropolitan Area Network (MAN). Various devices such as the requester-computing device 102, the database server 104, the application server 106, the crowdsourcing platform server 108, and/or the worker-computing device 110 may connect to the network 112 in accordance with various wired and wireless communication protocols such as Transmission Control Protocol/Internet Protocol (TCP/IP), User Datagram Protocol (UDP), and 2G, 3G, or 4G communication protocols.

FIG. 2 is a block diagram illustrating a system 200 for assigning one or more tasks to one or more workers, in accordance with at least one embodiment. The system 200 may comprise one or more processors, such as a processor 202, one or more memories, such as a memory 204, one or more transceivers, such as a transceiver 206, a fuzzy controller 208, and a comparator 210. The transceiver 206 is coupled to an input terminal 212 and an output terminal 214.

The system 200 may correspond to the application server 106 or the crowdsourcing platform server 108 without departing from the scope of the disclosure. For the purpose of the ongoing description, the system 200 has been considered as the application server 106.

The processor 202 may be configured to execute a set of instructions stored in the memory 204. The processor 202 may be coupled to the memory 204, the transceiver 206, the fuzzy controller 208 and the comparator 210. The processor 202 may execute a set of instructions/programs stored in the memory 204 to perform one or more operations. The processor 202 may be implemented based on a number of processor technologies known in the art. Examples of the processor 202 include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs having at least one code section executable by the processor 202. The memory 204 may store one or more sets of instructions and data. In an embodiment, the memory 204 may include a buffer 216, a first data structure 218, and a second data structure 220. Some of the commonly known memory implementations include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202 to perform specific operations. It will be apparent to a person having ordinary skill in the art that the one or more instructions stored in the memory 204 enables the hardware of the system 200 to perform the predetermined operation.

The transceiver 206 may be operable to communicate with the one or more devices, such as the requester-computing device 102, and/or one or more servers, such as the database server 104 over the network 112. The transceiver 206 may be operable to transmit and receive one or more micro-tasks to/from various components of the system environment 100. In an embodiment, the transceiver 206 is coupled to the input terminal 212 and the output terminal 214 through which the transceiver 206 may receive and transmit data/messages, respectively. In an embodiment, the input terminal 212 and the output terminal 214 may be realized through, but not limited to, an antenna, an Ethernet port, an USB port or any other port that can be configured to receive and transmit data. The transceiver 206 may transmit and receive data/messages in accordance with various communication protocols such as, TCP/IP, UDP, and 2G, 3G, or 4G communication protocols through the input terminal 212 and the output terminal 214.

The fuzzy controller 208 corresponds to a controller that employs one or more rules to translate human understandable values into a machine understandable values. In an embodiment, the fuzzy controller 208 may define one or more membership functions and a rule base (that includes one or more rules) to translate the human understandable values into the machine understandable values. For example, the fuzzy controller 208 may receive an input pertaining to a privacy level 226 of a task from the processor 202. In an embodiment, value of the privacy level 226 associated with a task may be the human understandable values such as high, medium, or low. The fuzzy controller 208 may utilize one or more rules in the rules base to translate privacy level 226 into a minimum number of hops, which may be a machine understandable value. The fuzzy controller 208 may be realized through various technologies such as, but not limited to, ASIC and SoC.

The comparator 210 is configured to compare an at least two input signals to generate an output signal. In an embodiment, the output signal may correspond to either ‘1’ or ‘0’. In an embodiment, the comparator 210 may generate output ‘1’ if the value of a first signal (from the at least two signals) is greater than a value of the second signal (from the at least two signals). Similarly, the comparator 210 may generate an output ‘0’ if the value of the first signal is less than the value of the second signal. In an embodiment, the comparator 210 may be realized through either software technologies or hardware technologies known in the art.

In operation, the processor 202 may receive worker data 222 from the database server 104. In an embodiment, the processor 202 may send a query to the database server 104 to retrieve the worker data 222. In an embodiment, the worker data 222 may include information pertaining to the social network activities performed by the one or more workers (e.g., activities of the one or more workers on social networking sites such as Facebook, Twitter, LinkedIn, and/or Pinterest), the locality information of the one or more workers, or past working history of the one or more workers. In an embodiment, the processor 202 receives the worker data 222 through the transceiver 206.

Post receiving the worker data 222, the processor 202 creates a first data structure 218 to organize the worker data 222. In an embodiment, the first data structure 218 is so created that an acquaintance between the one or more workers may be determined using the first data structure 218. In an embodiment, the first data structure 218 corresponds to a graph that includes one or more nodes and one or more edges that are used to connect the one or more nodes. In an embodiment, the one or more nodes are representative of the one or more workers and the one or more edges are used for defining the acquaintance between the one or more workers.

A person having ordinary skill the art would understand that the scope of the disclosure is not limited to the graph as the first data structure 218. In an embodiment, the first data structure 218 may correspond to a tree, a binary tree, doubly linked list, etc.

Post creation of the first data structure 218, the processor 202 may receive a request 224 from the requester-computing device 102 through the transceiver 206. In an embodiment, the request 224 may include one or more tasks that are to be crowdsourced. The processor 202 may segregate the request 224 to extract information pertaining to privacy level (depicted by 226) associated with the one or more tasks. The processor 202 may transmit the privacy level information (depicted by 226) to the fuzzy controller 208. Concurrently, the processor 202 segregates each of the one or more tasks in one or more sub-tasks. The processor 202 stores the one or more tasks (i.e., subsequent sub-tasks) in the buffer 216.

The fuzzy controller 208, on receiving the privacy level information (depicted by 226) from the processor 202, determines information pertaining to a minimum number of hops (depicted by 228) and a predetermined threshold value (depicted by 230). In an embodiment, the fuzzy controller 208 may employ the one or more membership functions and the one or more rules to determine the minimum number of hops and the predetermined threshold value (depicted by 230). The fuzzy controller 208 may transmit the information pertaining to the minimum number of hops (depicted by 228) and the predetermined threshold value (depicted by 230) to the processor 202.

The processor 202 creates one or more second data structures 220 based on the first data structure 218 and the minimum number of hops (received from the fuzzy controller 208). In an embodiment, a second data structure 220 includes information pertaining to an independent set of workers. In an embodiment, the workers in the independent set of workers are not acquainted with each other. All such sets of independent workers are stored in the one or more second data structures 220. The identification of the set of independent workers has been described later in conjunction with FIG. 4 and FIG. 5B. Further, the processor 202 retrieves information pertaining to a number of tasks previously attempted by each worker in a set of independent workers. The processor 202 transmits the information pertaining to the number of previously attempted tasks 232 to the comparator 210. The comparator 210 further receives the predetermined threshold value (depicted by 230) from the fuzzy controller 208. Thereafter, the comparator 210 compares the number of previously attempted tasks 232 for each worker in the set of independent workers, with the predetermined threshold value (depicted by 230). If the number of tasks attempted by a worker is greater than the predetermined threshold, the worker is not assigned any more tasks. In an embodiment, the processor 202 may identify such workers in each set of independent workers.

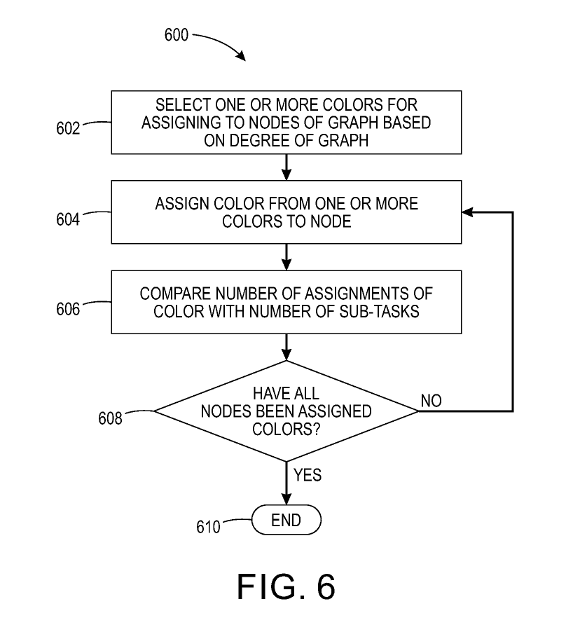

Thereafter, the processor 202 may retrieve a task and associated one or more sub-tasks from the buffer 216. The processor 202 may assign the one or more sub-tasks to the workers in the independent set of workers. In an embodiment, the assignment of the one or more tasks has been described later in conjunction with FIG. 6.

Based on the comparison, the comparator 210 identifies the workers, who have not worked together.

FIG. 3 is a flowchart 300 illustrating a method for assigning one or more tasks to one or more workers, in accordance with at least one embodiment. The flowchart 300 is described in conjunction with FIG. 1 and FIG. 2.

At step 302, the first data structure 218 to define an acquaintance between one or more workers is created. The first data structure 218 corresponds to a graph that includes one or more nodes and one or more edges that are used to connect the one or more nodes. In an embodiment, the processor 202 may create the graph. In an embodiment, the processor 202 may utilize the information pertaining to the one or more workers to create the graph. In an embodiment, the processor 202 may extract the information pertaining to the one or more workers from the database server 104. In an embodiment the information pertaining to the one or more workers may correspond to the worker data 222. As discussed, the database server 104 may collect the information from one or more sources such as, but not limited to, the social network of the one or more workers (e.g., Facebook, Twitter, LinkedIn, and/or Pinterest), the locality information of the one or more workers, or past working history of the one or more workers. The processor 202 may utilize the extracted information to determine the acquaintance between the workers. Based on the identified acquaintance, the processor 202 may place edges between different nodes (that represent the workers) to create the graph. For example, if the processor 202 determines that two workers (e.g., worker A and worker B) are connected on a social networking website (e.g., Facebook), then the processor 202 may join the two workers A and B by a single edge.

In an embodiment, the processor 202 may connect different workers (i.e. nodes in the graph) based on the geographical proximity between the workers. For example, if the processor 202 determines that the workers A and B are located within proximity of 2 KMs, then the processor 202 may join two nodes representing these two workers by an edge.

In an embodiment, the processor 202 may determine the acquaintance between two workers based on a historical data pertaining to the tasks performed by the workers. In an embodiment, the database server 104 may retrieve such information from the crowdsourcing platform server 108, and subsequently, the processor 202 may retrieve such information from the database server 104. For example, if the processor 202 determines that two workers have collaborated on a task previously (e.g., when both the worker have worked on the single task), then the processor 202 may consider both the workers acquainted and may join the nodes representing these two workers by an edge.

Further, in an embodiment, to compensate for any missed linkages between two nodes in the graph, the processor 202 may connect two nodes that are two hops away from each other. For example, if two workers are not direct friends on a social network, but are “friends of friends”, the processor 202 may connect the nodes corresponding to these two workers within the graph.

In an embodiment, the processor 202 may determine the acquaintance between the workers based on the conversations between the workers. It will be apparent to a person skilled in the art that various other types of information, based on the requirement of the requester, may also be considered while determining the acquaintance between the workers, without departing from the scope of the disclosure. In an embodiment, the requester may provide the criteria for determining the acquaintance between the workers. For example, the requester may specify that only those workers that are located in proximity of 2 KMs should be considered as acquainted with each other. In an embodiment, the processor 202 may determine the criteria for acquaintance automatically based on the retrieved information from the database server 104.

Thus, in this way, the graph may be augmented (by putting edges between different nodes) based on the acquaintances of different workers, such that the hop distance between different nodes will be representative of the acquaintance between respective nodes. For example, if two nodes are connected with a single edge, the two workers represented by the two nodes may be directly acquainted with each other. Whereas, if two nodes are two edges away, that means one node is acquaintance of other node's acquaintance. Further illustration of the creation of the graph has been discussed in conjunction with FIG. 5A.

At step 304, one or more second data structures pertaining to at least one set of workers is created from first data structure 218. The second data structure 220 includes information pertaining to an independent set of workers. In an embodiment, the workers in the independent set of workers are not acquainted with each other. All such sets of independent workers are stored in the one or more second data structures 220. In an embodiment, the processor 202 may identify the at least one set of independent workers. In an embodiment, workers in the set of independent workers are not acquainted with each other. Prior to identifying the set of independent workers, the processor 202 may receive one or more tasks from the requester. In addition, the requester may further specify a privacy level associated with the one or more tasks. For example, if a task relates to the form digitization (that includes handwritten content), the content in such forms may reveal information of the person who filled the form. Such tasks may have a high privacy level.

Post reception of the one or more tasks, the processor 202 may segregate each of the one or more tasks into one or more sub-tasks. For example, in a scenario where each of the one or more tasks corresponds to form digitization, the processor 202 may divide the form based on the fields in the form. As each field independently may not reveal information of the person who filled the form, the processor 202 may create a sub-task out of each such field of the form. Hence, the worker who may attempt the sub-task may not be able to use the information (portion of the form embedded in the sub-task) to reveal information about the person who filled the form.

In an embodiment, the processor 202 may segregate the one or more tasks such that a number of sub-tasks so created are same for each of the one or more tasks. For example, the processor 202 receives 10 forms for digitization as the one or more tasks, where digitization of each such form corresponds to a task. Each form may have a similar template. Thus, it may be desirable to divide each form in a similar manner. For instance if the first form is divided into three portions such that the three portions include the fields “name”, “address”, “telephone number” respectively, the remaining forms are accordingly divided in a similar fashion.

In an embodiment, the processor 202 may store the one or more segregated tasks and the one or more sub-tasks corresponding to each such task in the buffer 216.

In an embodiment, the processor 202 may identify the set of independent workers based on a number of sub-tasks in a task, a number of tasks received from the requester, a number of nodes (representing workers) in the graph, a privacy level associated with the task, and a degree of the graph. The identification of set of independent workers has been described in conjunction with FIG. 4 and FIG. 5B.

At step 306, the one or more sub-tasks associated with each of the one or more tasks are assigned to the one or more workers. In an embodiment, the processor 202 may assign the one or more sub-tasks (in a single task) to the one or more workers in the set of independent workers (identified from the graph in step 304). As discussed above, each task (received) is divided into one or more sub-tasks such that a sub-task independently does not reveal any privacy information. Further, as discussed, each task, received from the requester, is divided into the same number of sub-tasks. Further, the processor 202 may identify the at least one set of independent workers in such a manner that number of workers in the at least one set of independent workers is greater than or equal to the number of sub-tasks. For instance, the number of workers in the at least one set of independent workers is at least three if the number of sub-tasks in a task are three.

The processor 202 may assign the one or more sub-tasks (obtained from the task) to workers in the at least one set of independent workers. Since the workers included in the independent set do not interact, hence they may not be acquainted with each other. Accordingly, distribution of sub-tasks associated with the same task to such workers may not reveal the privacy information included in that task.

Similarly, other tasks obtained from the requester are assigned to other set of independent workers identified by the processor 202. For example, the processor 202 receives three tasks from the requester and identifies three set of independent workers. The processor 202 may assign these tasks to the three sets of independent workers such that each set of independent workers has at least one task each. Further, sub-tasks from these tasks are attempted by the workers in respective sets of independent workers. Assignment of tasks is described in more detail in conjunction with FIG. 6.

It will be apparent to a person skilled in the art that a worker, who is not well connected with other workers, may be present in more than one set of independent workers. In such a scenario, to avoid a situation where that a worker is assigned too many tasks, the processor 202 may define a threshold number of tasks that can be assigned to the worker. In an embodiment, the threshold number may be provided by the requester, without departing from the scope of the disclosure.

FIG. 4 is a flowchart 400 illustrating a method to determine set of independent workers, in accordance with at least one embodiment. The flowchart 400 is described in conjunction with FIG. 1, FIG. 2, and FIG. 3.

At step 402, the one or more tasks are received from the requester. In an embodiment, the processor 202 may receive the one or more tasks. In an embodiment, the requester may access the application server 106 or the crowdsourcing platform server 108 using the requester-computing device 102 to transmit/receive information pertaining to the one or more tasks to/from the crowdsourcing platform server 108 over the network 112. In addition to the one or more tasks, the requester may provide information pertaining to the privacy level (depicted by 226) associated with each of the one or more tasks. In an embodiment, the privacy level (depicted by 226) may be a measure of risk involved with private information being revealed to the worker who attempts the task. In an embodiment, the information pertaining to the one or more tasks and the privacy level (depicted by 226) associated with the one or more tasks may correspond to the request 224.

At step 404, the privacy level information (depicted by 226) is extracted from the one or more tasks. The processor 202 may extract this privacy level information (depicted by 226) from the one or more tasks.

At step 406, minimum number of hops between at least two nodes in the graph is determined based on the privacy level 226. The processor 202 may translate the privacy level information (depicted by 226) provided by the requester to a minimum number of hops between two nodes. In an embodiment, the processor 202 may utilize the fuzzy controller 208 to determine the minimum number of hops based on the privacy level information (depicted by 226) associated with the one or more tasks. In an embodiment, the minimum number of hops corresponds to a number of hops between two nodes in the graph (created in step 302) that may deem the two nodes to be connected or related. In an embodiment, the processor 202 may utilize a lookup table that may be used for translating the privacy level (provided by the requester) to the minimum number of hops. Following table illustrates an example lookup table:

TABLE 1
Example of look-up table

| Level of privacy | Minimum number of hops |
|---|---|
| High | 5 |
| Medium | 3 |
| Low | 2 |

A person having ordinary skill in the art would appreciate that the scope of the disclosure is not limited to determining the minimum number of hops by utilizing the look-up table. In an embodiment, the processor 202 may employ any technique (e.g., fuzzy logic, one or more if-else rules, etc.) to translate the minimum number of hops from the level of privacy. In an embodiment, one or more rules within the rule base of the fuzzy controller 208 may be utilized to determine the minimum number of hops for a given level of privacy.

At step 408, a set of independent nodes are identified based on the minimum number of hops. In an embodiment, the processor 202 may determine the set of independent nodes. As the nodes in the graph are representative of the one or more workers, identifying the set of independent nodes is equivalent to identification of the set of independent workers.

In order to identify the set of independent nodes, the processor 202 may select a node in the graph randomly. Thereafter, the processor 202 may traverse through the graph along the edges. For each node encountered during the traversing of the graph, the processor 202 increments a counter indicative of the number of hops. The processor 202 compares the value of the counter with the minimum number of hops (determined in step 406). If the value of the counter is greater than or equal to the minimum of the hops, the processor 202 selects the node to be a part of set of independent nodes. In an embodiment, the process of step 408 may be repeated by the processor 202 until the number of nodes in the set of independent nodes is equal to the number of sub-tasks in the one or more tasks (determined in step 304). In an embodiment, the processor 202 may utilize the comparator 210 to compare the current value of the counter indicative of the number of hops and the minimum number of hops.

In an embodiment, the processor 202 may repeat the step 408 to identify other independent set of nodes from the graph. A person having ordinary skill in the art would understand that while traversing the graph, the processor 202 performs another check to determine whether the node is a part any other set of independent nodes. If the processor 202 determines that a node in the graph is a part of any other set of independent nodes, the processor 202 may skip or ignore the node and may proceed with the traversing of the graph.

In an embodiment, the identified sets of independent nodes correspond to one or more sets of independent workers. The processor 202 may assign the task to one or more sets of independent workers.

FIG. 5A is a graph 500 illustrating acquaintances between the one or more workers, in accordance with an embodiment. The graph 500 is described in conjunction with FIG. 1, FIG. 2, FIG. 3 and FIG. 4.

In an embodiment, the graph 500 may comprise plurality of nodes, such as nodes 502a, 502b, 502c, 502d, 502e, 502f, 502g, 502h, and 502i. In an embodiment, each node in the graph 500 may represent a worker. In an embodiment, the graph 500 may comprise plurality of edges, such as edges 504a, 504b, 504c, 504d, 504e, 504f, 504g, 504h, 504i, and 504j. In an embodiment, each edge may represent an acquaintance/link between two workers. In an embodiment, the processor 202 may generate the graph 500 representative of acquaintances between the one or more workers. As discussed, the processor 202 may utilize the information pertaining to the one or more workers to generate the graph 500. The processor 202 may utilize the extracted information to determine the acquaintances between the workers. Based on the identified acquaintances, the processor 202 may place edges between different nodes (that represent the workers) to generate the graph 500. For example, if the processor 202 determines that two workers (e.g., worker A represented by node 502a and worker B represented by node 502b) are known to each other by any means, then the processor 202 may join the two workers A and B by a single edge 504a as shown in FIG. 5a. If the processor 202 determines that two workers (e.g., worker A represented by node 502a and worker G represented by node 502g) are not known to each other by any means, then the processor 202 may not join the two workers A and G as shown in FIG. 5A. In an embodiment, the graph 500 may be further augmented by adding edges to protect against weak ties or links to expand the protective capabilities.

FIG. 5B is the graph 500 illustrating identification of the one or more sets of independent workers, in accordance with an embodiment of the present disclosure. The graph 500 is described in conjunction with FIG. 1, FIG. 2, FIG. 3, FIG. 4 and FIG. 5A.

For the purpose of ongoing description, the minimum number of hops has been considered to be two. As described in conjunction with step 408, to identify the set of independent nodes, the processor 202 may select a node from the graph 500 randomly. For instance, the processor 202 selects the node 502a. Thereafter, the processor 202 may traverse the graph 500 through the edge 504a to node 502b. As the node 502b is at a distance of one hop from the node 502a and the minimum number of hops is two, the processor 202 may ignore the node 502b. Similarly, the processor 202 traverses to the node 502c via the edge 504b. The processor 202 may select the node 502c. The node 502c and the node 502a may be added to a first set of independent nodes. The processor 202 continues the traversing through the graph 500 until the number of nodes in the first set of independent nodes is equal to the number of sub-tasks. For instance, if the number of sub-tasks is three, the first set of independent nodes (denoted by 506a) may include the nodes 502a, 502 c, and 502f.

Post identifying the first of independent nodes, the processor 202 may similarly identify other sets of independent nodes in the graph 500. For example, nodes 502e, 502i, and 502d may constitute a second set of independent nodes (denoted by 506b). Similarly, other sets of independent nodes may be determined from the graph 500. As the nodes represent the one or more workers, the sets of independent nodes identified are representative of the sets of independent workers.

FIG. 6 is a flowchart 600 illustrating another method to identify one or more sets of independent workers, in accordance with at least one embodiment. The flowchart 600 has been described in conjunction with FIG. 1, FIG. 2, FIG. 3, FIG. 4, and FIG. 5A.

At step 602, one or more colors are selected. In an embodiment, the processor 202 may choose the one or more colors based on the degree of the graph. In an embodiment, the degree of the graph corresponds to maxima of number of edges associated with each node in the graph. For example, the degree of the graph 500 (shown in FIG. 5A) is three, as number of edges originating from the nodes 502e and 502g is three. In an embodiment, the processor 202 may select 2*Δ+1 colors, where Δ corresponds degree of the graph.

At step 604, a color from the one or more colors is assigned to a node in the graph 500. In an embodiment, the processor 202 may assign the color to the node. In an embodiment, the processor 202 selects the color for assigning to the node in such a manner that the color has not been used for any of the neighboring nodes in the graph 500. In an embodiment, the neighboring nodes are determined based on the minimum number of hops determined in the step 406. For instance, if the minimum number of hops is one, the colors assigned to immediate neighbors of the node (i.e., nodes at a distance of one hop from the node) are taken into account before assigning the color to the node. If the minimum number of hops is two, the processor 202 checks the color of the nodes that are at a distance of at most two hops and accordingly assigns the color to that node. The color is so selected from the one or more colors that none of the nodes up to the distance of two hops have the same color.

At step 606, the number of instances where the color is assigned to the nodes of the graph (in step 604) is compared with the number of sub-tasks. In an embodiment, the processor 202 may compare the number of instances where the color is assigned to the nodes of the graph with the number of sub-tasks. In an embodiment, the processor 202 may utilize the comparator 210 to compare the number of instances of the assignment of the color with the number of sub-tasks. If the number of instances of the color having being used is equal to the number of sub-tasks, the processor 202 may select a second color that has not been assigned to any other neighboring nodes. Further, the second color is such that the number of instances of assignment of the second color is less than the number of sub-tasks. In an embodiment, the processor 202 may select the second color for the node.

At step 608, a check is performed to determine if all the nodes have been assigned a color from the one or more colors. In an embodiment, the processor 202 performs the check. If the processor 202 determines that all the nodes have been assigned colors, the process of flowchart 600 ends (at step 610). If at step 608, it is determined that not all the nodes have been assigned the color, step 604 is performed. Steps 604 to 608 are repeated until all the nodes in the graph are colored. In an embodiment, the processor 202 may store the information pertaining to the identified sets of workers in the database server 104.

A person having ordinary skill in the art would understand that the check at step 608 is performed by the processor 202 by traversing through the graph 500. However, the scope of the disclosure should not be limited to performing the check by traversing through the graph 500. In an embodiment, the processor 202 may maintain an index that includes the information pertaining to the one or more nodes in the graph 500 and corresponding colors assigned to the one or more nodes.

In an embodiment, the number of sets of independent workers identified from the graph is Δ+1.

In an embodiment, the nodes assigned the same color are the set of independent nodes that are not related with each other. As the nodes are representative of the one or more workers, the sets of independent nodes correspond to the sets of independent workers.

In order to allocate tasks to the one or more workers, the information pertaining to the sets of independent workers is extracted from the database server 104. In an embodiment, the processor 202 extracts the information pertaining to the sets of independent workers.

Concurrently, the processor 202 extracts the data pertaining to the one or more tasks from the database server 104. In an embodiment, the data further includes the information pertaining to the one or more sub-tasks in each of the one or more tasks. For the purpose of the ongoing description, following representations are used:
subtasks of a task={F1; F2; . . . ; Fp}
number of workersd in sets of independent workers=s₁, s₂, s₃, . . . , s_{Δ+1}

In an embodiment a single task is allocated to a single set of independent workers. All the sub-tasks present in the task are attempted by the workers of the set of independent workers. As the set of workers are independent/unrelated to each other, privacy of the task may be maintained.

In an alternate embodiment, the processor 202 may extract a first sub-task from each of the one or more tasks. The count of the number of sub-tasks extracted from each of the one or more tasks is f*(p/n), where f corresponds to number of tasks, p corresponds to number of sub-tasks in each of the one or more tasks, and n corresponds to total number of workers.

Once all the first sub-tasks from each of the one or more tasks are allocated, the processor 202 may select a second sub-task from each of the one or more tasks. Thus, no worker may be assigned two sub-tasks from same task. Further, the processor 202 performs a check to determine number of sub-tasks allocated to each worker. If the number of sub-tasks allocated to the worker is determined to be equal to a predetermined threshold, the processor 202 may not further allocate sub-tasks to such workers.

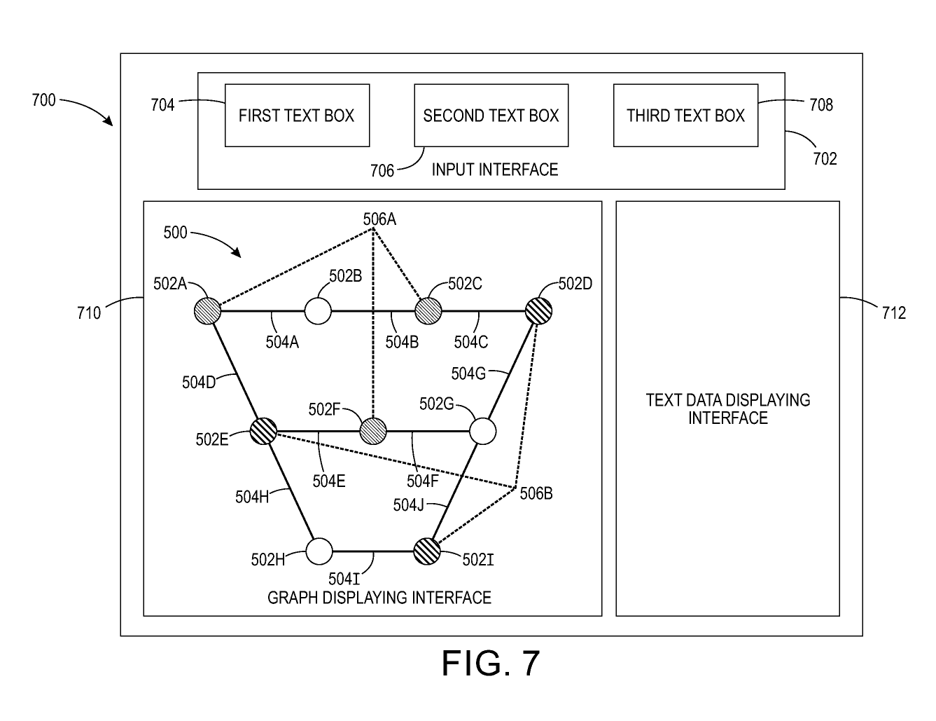

FIG. 7 is a block diagram illustrating a graphical user interface (GUI) 700 for transmitting or receiving information pertaining to the one or more tasks. In an embodiment the GUI 700 may be presented to the requester on the requester computing device 102. In an embodiment, the GUI 700 may comprise one or more interfaces such as, but not limited to, an input interface 702, a graph displaying interface 710, and a text data displaying interface 712. The GUI 700 may be utilized by the requester to transmit or receive the information pertaining to the one or more tasks.

In an embodiment, the requester may utilize the input interface 702 to transmit the information pertaining to the one or more tasks. The input interface 702 may comprise one or more interface elements such as, but not limited to, a first text box 704, a second text box 706, and a third text box 708. In an embodiment, the requester may utilize the first text box 704 to transmit the one or more tasks to the crowdsourcing platform. In another embodiment, the requester may utilize the first text box 704 to transmit the one or more sub-tasks to the crowdsourcing platform. In an embodiment, the requester may utilize the second text box 706 to transmit the information pertaining to the number of sub-tasks of the task. In an embodiment, the requester may utilize the second text box 706 to provide one or more instructions about how to perform the tasks. In an embodiment, the requester may utilize the third text box 708 to transmit information pertaining to the generation of the graph 500. The requester may provide the criteria for determining the acquaintance between the workers. The requester may provide the privacy level (depicted by 226) associated with the one or more tasks. The requester may provide minimum number of hops required for generating the graph 500. The requester may provide the size of the independent sets of workers.

The requester may utilize the graph displaying interface 710 to receive the graph 500. The processor 202 may utilize the information pertaining to the one or more tasks to generate the graph 500. The application server 106 may transmit the graph 500 to the graph displaying interface 710 over the network 112. In an embodiment, the requester may select one or more independent sets of workers based on the graph 500 displayed on the graph displaying interface 710. In an embodiment, one or more text data associated with the graph 500 may be displayed on the text data displaying interface 712. The text data displaying interface 712 may display the information pertaining to the graph 500. The information pertaining to the graph 500 may comprise, but is not limited to, number of independent sets of workers, number of workers in each independent sets, and minimum number of hops utilized for generating the graph 500.

A person skilled in the art would appreciate that the scope of the disclosure is not limited to the GUI 700 as described above. The GUI 700 may be implemented with one or more variations without departing from the spirit of the disclosure.

Various embodiments of the disclosure lead to preservation of private information within the tasks. The disclosure provides for identification of sets of independent workers that may not be as such acquainted with or know one another. To determine whether two workers are unacquainted, various checks are performed such as whether the workers are directly/indirectly (up to a pre-defined level) connected on social network sites, the workers are geographically proximate to each other (e.g., they stay in the same locality), or the workers have previously collaborated on tasks. If the workers are determined as unacquainted based on such checks, the workers may be assigned sub-tasks from the same task. Assignment of the tasks to such unacquainted workers may avoid collusion among the workers, and hence preserve private information included within the tasks.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, “C,” “C++,” “Visual C++,” Java, and “Visual Basic.” Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for assigning one or more tasks to one or more workers have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A system for assigning one or more tasks to one or more workers, said system comprising:
a transceiver configured to receive a request from a computing device associated with a requester over a network, wherein said request comprises at least said one or more tasks and a privacy level associated with said one or more tasks;
a processor configured to:
create a first data structure to define an acquaintance between said one or more workers, based on at least a previous collaboration among said one or more workers in attempting at least previous tasks;
create one or more second data structures from said first data structure, wherein each of said one or more second data structures stores information pertaining to at least one set of workers from said one or more workers and said privacy level, and wherein workers in said at least one set of workers are unacquainted with each other; and
a buffer configured to store one or more sub-tasks in a task, wherein said processor pulls said one or more sub-tasks from said buffer to assign said one or more sub-tasks to said workers in said at least one set of workers such that said task assigned to said at least one set of workers is different from tasks assigned to other sets of workers.

2. The system of claim 1, wherein said first data structure corresponds to a graph comprising one or more nodes and one or more edges, wherein said one or more edges connects said one or more nodes.

3. The system of claim 2, wherein said one or more nodes are representative of said one or more workers.

4. The system of claim 2, wherein said one or more edges are representative of said acquaintance between said one or more workers.

5. The system of claim 2 further comprising a fuzzy controller configured to translate said privacy level to a minimum number of hops between at least two nodes, from said one or more nodes in said graph, wherein hops between said at least two nodes are indicative of a number of edges between said at least two nodes in said graph.

6. The system of claim 5, wherein a number of hops between said workers in said at least one set of workers, in said graph, is greater than said minimum number of hops.

7. The system of claim 1, further comprising a comparator, wherein said comparator compares a number of previously attempted tasks by said workers with a threshold value of number of tasks.

8. The system of claim 7, wherein said one or more sub-tasks are assigned based on said comparison.

9. The system of claim 7, wherein said first data structure is created based on at least activity of said one or more workers on one or more websites, and a geographical location of said one or more workers, wherein said one or more websites correspond to at least one or more social networking websites, or blogs.

10. A method for assigning one or more tasks to one or more workers, said method comprising:
receiving, by a transceiver, a request from a computing device associated with a requester, over a network, wherein said request comprises at least said one or more tasks and a privacy level associated with said one or more tasks, and wherein said one or more tasks are stored in a buffer;
storing, by a processor, information pertaining to said one or more workers in a first data structure such that said first data structure defines an acquaintance between said one or more workers based on at least a previous collaboration among said one or more workers in attempting at least previous tasks;
identifying, by said processor, at least one set of workers from said one or more workers based on said privacy level, wherein workers in said at least one set of workers are unacquainted with each other, and wherein information pertaining to said at least one set of workers is stored in one or more second data structures; and
extracting, by said processor, one or more sub-tasks from a task, stored in said buffer to assign said one or more sub-tasks to said workers in said at least one set of workers such that said task assigned to said at least one set of workers is different from tasks assigned to other sets of workers.

11. The method of claim 10, wherein said first data structure corresponds to a graph comprising one or more nodes and one or more edges, wherein said one or more edges are utilizable to determine a connection between said one or more nodes.

12. The method of claim 11, wherein said one or more nodes are representative of said one or more workers.

13. The method of claim 11, wherein said one or more edges are representative of a relation between said one or more workers.

14. The method of claim 11 further comprising translating, by a fuzzy controller, said privacy level to a minimum number of hops between at least two nodes, from said one or more nodes in said graph, wherein hops between said at least two nodes are indicative of a number of edges between said at least two nodes in said graph.

15. The method of claim 14, wherein a number of hops between said workers in said at least one set of workers, in said graph, is greater than said minimum number of hops.

16. The method of claim 10, further comprising comparing, by a comparator, a number of tasks previously attempted by said workers with a predetermined threshold, wherein said task is assigned based on said comparison.

17. The method of claim 10, wherein said first data structure is created based on at least activity of said one or more workers on one or more websites, and a geographical location of said one or more workers, wherein said one or more websites correspond to at least one or more social networking websites, or blogs.
